(19) United States
(12) Patent Application Publication
(10) Pub. No.: US 2022/0239618 A1
(43) Pub. Date: Jul. 28, 2022

(54) ANSWERING SYSTEMS AND METHODS FOR VOICE TO TEXT TRANSITION

(71) Applicant: META PLATFORMS, INC., Menlo Park, CA (US)

(72) Inventors: Tudor-Corneliu Sapunaru, London (GB); Ziad Traboulsi, Singapore (SG)

(73) Assignee: META PLATFORMS, INC., Menlo Park, CA (US)

(21) Appl. No.: 15/906,965

(22) Filed: Feb. 27, 2018

(51) Int. Cl. H04L 12/58; G10L 15/26

(52) U.S. Cl. CPC H04L 51/32; G10L 15/265; H04L 51/02

(57) ABSTRACT

Systems, methods, and non-transitory computer-readable media can establish a voice communication with a computing device over one or more networks, wherein the voice communication was initiated by a user operating the computing device, and wherein the computing system is associated with an entity; determine a user selection of an option to interact with one or more representatives of the entity over a messaging session, the option being provided by the computing system during the voice communication; and establish the messaging session between the user operating the computing device and at least one representative of the entity.

### FIELD OF THE INVENTION

The present technology relates to the field of interacting with computing devices (or systems). More particularly, the present technology relates to techniques for interacting with automated answering systems.

### BACKGROUND

Today, people often utilize computing devices (or systems) for a wide variety of purposes. Users can use their computing devices to, for example, interact with one another, create content, share information, and access information. In some instances, a user can access a software application running on a computing device to make and receive voice calls. In some instances, a voice call between a mobile device of the user and a computing device of an entity may be established by utilizing various technologies for delivering voice, or multimedia, communications over a network (e.g., the Internet, cellular networks, etc.).

### SUMMARY

Various embodiments of the present disclosure can include systems, methods, and non-transitory computer readable media configured to establish a voice communication with a computing device over one or more networks, wherein the voice communication was initiated by a user operating the computing device, and wherein the computing system is associated with an entity; determine a user selection of an option to interact with one or more representatives of the entity over a messaging session, the option being provided by the computing system during the voice communication; and establish the messaging session between the user operating the computing device and at least one representative of the entity.

In some embodiments, the user and the at least one representative are able to exchange text-based messages through the messaging session.

In some embodiments, the at least one representative is an automated chat bot.

In some embodiments, the messaging session is established through a social networking system.

In some embodiments, the option for interacting with the entity over the messaging session is provided among a menu of options for interacting with the entity.

In some embodiments, the systems, methods, and non-transitory computer readable media are configured to determine an address associated with the computing device; determine a username of the user based at least in part on the address; and cause at least one text-based message addressed to the username be sent through a social networking system.

In some embodiments, the systems, methods, and non-transitory computer readable media are configured to determine a username that corresponds to a phone number associated with the computing device.

In some embodiments, the systems, methods, and non-transitory computer readable media are configured to determine an address associated with the computing device; and cause at least one text-based message to be sent to the address, the text-based message including an option for messaging the entity over a social networking system.

In some embodiments, the at least one text-based message is sent to a phone number associated with the computing device, and wherein selection of the option permits the user to send an instant message to at least one representative of the entity over the social networking system.

In some embodiments, the computing system is an automated answering system.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system, according to an embodiment of the present disclosure.

FIG. 2 illustrates an example client module, according to an embodiment of the present disclosure.

FIG. 3 illustrates an example automated answering module, according to an embodiment of the present disclosure.

FIG. 4 illustrates an example of a messaging system module, according to an embodiment of the present disclosure.

FIGS. 5A-5C illustrate example methods, according to an embodiment of the present disclosure.

FIG. 6 illustrates a network diagram of an example system including an example social networking system that can be utilized in various scenarios, according to an embodiment of the present disclosure.

FIG. 7 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

Approaches for Interacting with Answering Systems

People use computing devices (or systems) for a wide variety of purposes. For example, a user operating a computing device can initiate a voice call over a network using, for example, a software application running on the computing device. In some instances, when a user calls an entity, the call may be answered by an automated answering system (e.g., automated attendant, interactive voice response, etc.). In general, an automated answering system is configured to process voice calls using an automated menu (e.g., phone tree, telephony menu, automated attendant menu, interactive voice response menu, etc.) that provides callers with various options. Such options are typically communicated using pre-recorded audio by the automated answering system and may allow the user to route a call and/or query information, for example. The caller can select options, for example, by pressing the appropriate numerical key through a virtual keypad that is presented on a display screen of the user's computing device. The virtual keypad typically may include a corresponding numerical key for each digit in the 0-9 numerical range. In general, selecting a numerical key through the virtual keypad may cause a corresponding DTMF tone (dual-tone multi-frequency signaling), or some other appropriate signal, to be sent to the automated answering system. The automated answering system can determine the selected option based on the DTMF tone and can process the request accordingly. Such conventional approaches for automated answering systems can be undesirable for a number of reasons. For example, users typically need to wait for the automated answering system to audibly communicate the available options before being able to determine which option to select. This process is especially inefficient when many options are available for selection and the user's desired option is repeated last. These existing approaches can also be undesirable for users that are hearing impaired since such users may have difficulty understanding options that are available for selection. Accordingly, such conventional approaches may not be effective in addressing these and other problems arising in computer technology.

An improved approach rooted in computer technology overcomes the foregoing and other disadvantages associated with conventional approaches specifically arising in the realm of computer technology. In various embodiments, an automated answering system of a given entity can provide an option that allows users to interact with the entity over a different communication channel. For example, in some embodiments, a user interacting with the automated answering system during a voice call can select an option to communicate with the entity using text-based messages. In such embodiments, the user can communicate with representatives of the entity by sending and receiving messages that are exchanged over one or more networks (e.g., the Internet, cellular networks, etc.). As a result, the disclosed inventive solution provides a handover mechanism that allows users (or callers) to switch from an established voice call with an automated answering system of an entity to a text-based communication with representatives of the entity through a different messaging system (e.g., a social networking system, business to consumer messaging systems). In some embodiments, some representatives of the entity may be automated chat bots that are trained to analyze and provide responses to text-based queries submitted by users within messages sent through the messaging system. Such text-based queries may include, for example, “What is my account balance?”, “How much is my bill this month?”, or “I want to order a product”, to name some examples. In such embodiments, the automated chat bots can be trained based on various artificial intelligence techniques including, for example, machine learning. Many variations are possible.

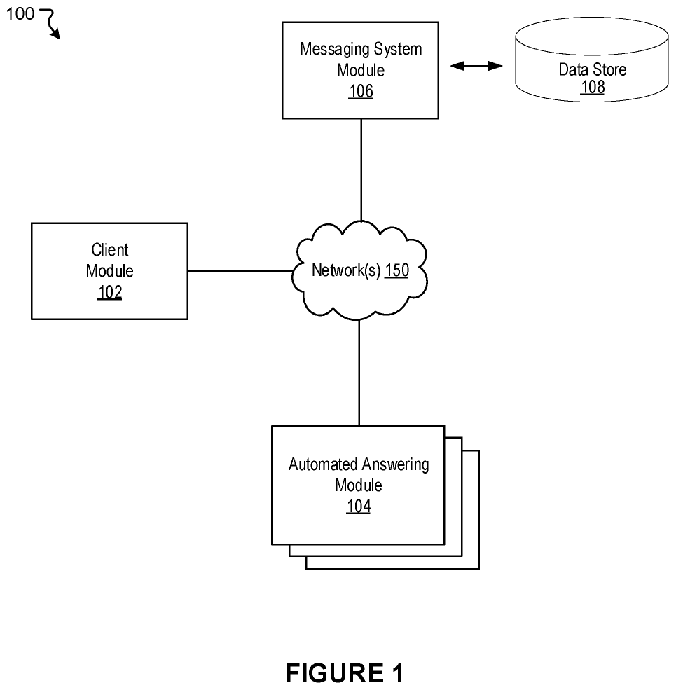

FIG. 1 illustrates an example system 100, according to an embodiment of the present disclosure. As shown in the example of FIG. 1, the system 100 can include a client module 102, an automated answering module 104, and a messaging system module 106. In some instances, the example system 100 can include at least one data store 108. The client module 102, the automated answering module 104, and the messaging system module 106 can interact with one another over one or more networks 150. In various embodiments, the network 150 can be any wired or wireless computer network through which devices can exchange data. For example, the network 150 can be a personal area network, a local area network, or a wide area network, to name some examples. The components (e.g., modules, elements, etc.) shown in this figure and all figures herein are exemplary only, and other implementations may include additional, fewer, integrated, or different components. Some components may not be shown so as not to obscure relevant details.

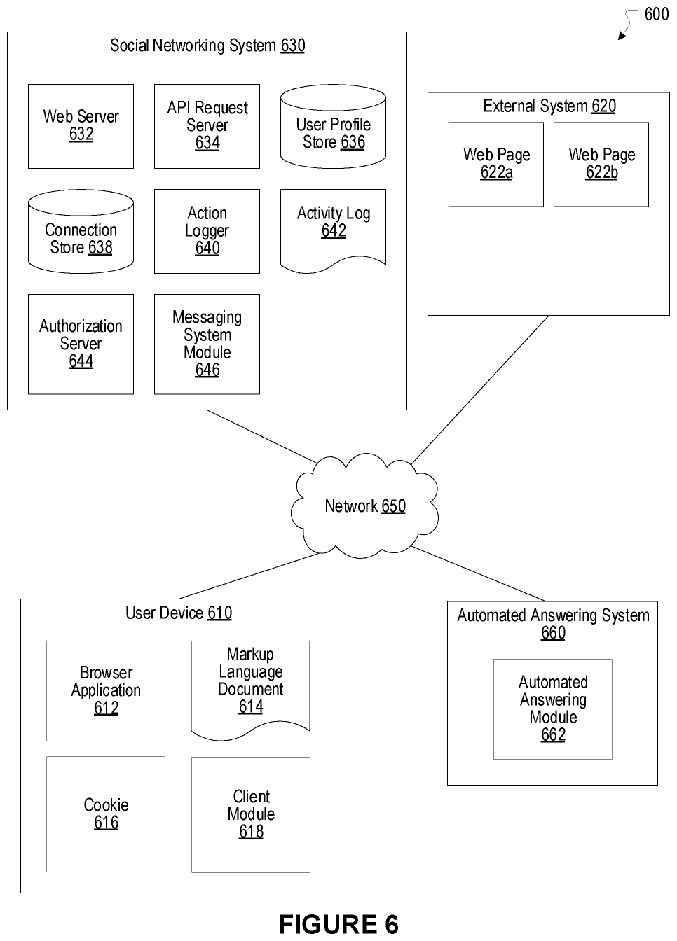

In some embodiments, the client module 102, the automated answering module 104, and the messaging system module 106 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the client module 102, the automated answering module 104, and the messaging system module 106 or at least portions thereof can be implemented using one or more computing devices or systems that include one or more servers, such as network servers or cloud servers. In some instances, the client module 102, the automated answering module 104, and the messaging system module 106 can, in part or in whole, be implemented within or configured to operate in conjunction with a social networking system (or service), such as the social networking system 630 of FIG. 6. In some instances, the client module 102 can be, in part or in whole, implemented within or configured to operate in conjunction or be integrated with a client computing device, such as the user device 610 of FIG. 6. The client module 102, the automated answering module 104, and the messaging system module 106 can be implemented as or within a dedicated application (e.g., app), a program, or an applet running on a user computing device or client computing system. The application incorporating or implementing instructions for performing some, or all, functionality of the client module 102, the automated answering module 104, and the messaging system module 106 can be created by a developer. The application can be provided to or maintained in a repository. In some cases, the application can be uploaded or otherwise transmitted over a network (e.g., Internet) to the repository. For example, a computing system (e.g., server) associated with or under control of the developer of the application can provide or transmit the application to the repository. The repository can include, for example, an “app” store in which the application can be maintained for access or download by a user. In response to a command by the user to download the application, the application can be provided or otherwise transmitted over a network from the repository to a computing device associated with the user. For example, a computing system (e.g., server) associated with or under control of an administrator of the repository can cause or permit the application to be transmitted to the computing device of the user so that the user can install and run the application. The developer of the application and the administrator of the repository can be different entities in some cases, but can be the same entity in other cases. It should be understood that many variations are possible.

In some embodiments, the messaging system module 106 can be configured to communicate and/or operate with the at least one data store 108 in the example system 100. The at least one data store 108 can be configured to store and maintain various types of data. In various embodiments, the at least one data store 108 can store data relevant to function and operation of the messaging system module 106. One example of such data can be mappings between user addresses (or identifiers) (e.g., phone numbers) and usernames (or logins) in a messaging system (e.g., the social networking system 630 of FIG. 6). In some embodiments, user addresses (or identifiers) (e.g., phone numbers) are used as logins in a messaging system (e.g., the social networking system 630 of FIG. 6). In such embodiments, mappings between the user addresses (or identifiers) (e.g., phone numbers) and usernames (or logins) in the messaging system are not needed. In some implementations, the at least one data store 108 can store information associated with the social networking system (e.g., the social networking system 630 of FIG. 6). The information associated with the social networking system can include data about users, social connections, social interactions, locations, geo-fenced areas, maps, places, events, pages, groups, posts, communications, content, feeds, account settings, privacy settings, a social graph, and various other types of data. In some implementations, the at least one data store 108 can store information associated with users, such as user identifiers, user information, profile information, user specified settings, content produced or posted by users, and various other types of user data. It should be appreciated that there can be many variations or other possibilities.

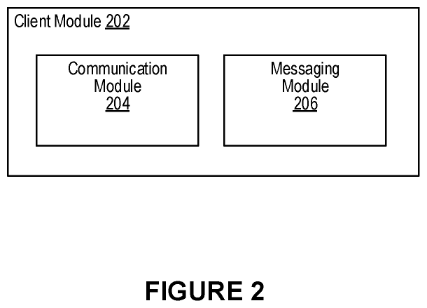

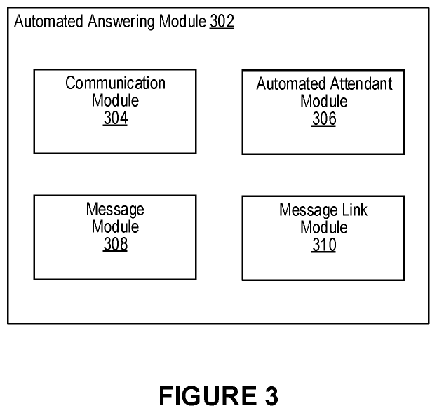

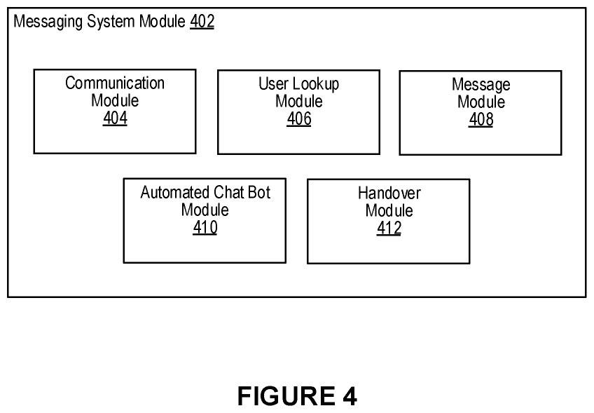

The client module 102 may be configured to initiate voice communications (or calls) when an address (e.g., phone number) is selected or dialed. For example, a user operating a computing device in which the client module 102 is implemented may initiate a voice call with an entity by dialing a phone number associated with the entity through a software application (e.g., phone application) running on the computing device. Once initiated, the voice call may be answered by an automated answering system associated with the entity. In this example, the automated answering system can implement the automated answering module 104. The automated answering module 104 can be configured to answer, or service, any voice calls that are directed to the phone number associated with the entity. In general, the automated answering module 104 can be configured to process voice calls using an automated menu (e.g., phone tree, telephony menu, automated attendant menu, interactive voice response menu, etc.) that provides callers with various options. Such options can be communicated using pre-recorded audio by the automated answering module 104 and may allow the user to route a call (e.g., “press 1 for sales, press 2 for customer support, or press 3 for all other inquiries”) and/or query information (e.g., “press 1 to hear your checking account balance or press 2 to hear your savings account balance”), for example. The caller can select options, for example, by pressing the appropriate numerical key through a virtual keypad that is presented on a display screen of the user's computing device. In various embodiments, the automated answering module 104 can also provide an option that allows the caller to convert the voice call to a text-based communication. In some embodiments, the automated answering module 104 can automatically convert the voice call to a text-based communication. In some embodiments, when the call is converted to a text-based communication, one or more text-based messages can be sent from the entity to the caller through a messaging system (e.g., a social networking system) that implements the messaging system module 106. In this example, the user (or caller) can communicate with a representative of the entity using text-based messages exchanged over one or more networks and through the messaging system in which the messaging system module 106 is implemented. In some embodiments, the messaging system module 106 can be configured to service text-based messages using one or more automated chat bots and/or live agents (e.g., customer service representatives) that respond to user inquiries. Many variations are possible. More details regarding the client module 102 will be provided below in reference to FIG. 2. More details regarding the automated answering module 104 will be provided below in reference to FIG. 3. More details regarding the messaging system module 106 will be provided below in reference to FIG. 4.

FIG. 2 illustrates an example client module 202, according to an embodiment of the present disclosure. In some embodiments, the client module 102 of FIG. 1 can be implemented with the client module 202. As shown in the example of FIG. 2, the client module 202 can include a communication module 204 and a messaging module 206.

The communication module 204 can be configured to utilize various technologies for receiving and/or establishing voice-based communications (or calls) over various networks (e.g., the Internet, cellular networks, POTS networks, etc.). In some embodiments, the communication module 204 can establish a voice-based communication (or call) with an entity using an address associated with the entity. In some instances, the address used to establish the voice-based communication may be a phone number, a Uniform Resource Locator (URL), an e-mail address, user id, or some other address for routing traffic in a network, such as an Internet Protocol (IP) address. Many variations are possible.

The messaging module 206 can provide a messaging interface for exchanging messages between users. In some embodiments, the messaging interface provides options for exchanging messages with users of a messaging system (e.g., the messaging system module 106 of FIG. 1) through one or more computer networks. In some embodiments, the messaging system corresponds to a social networking system 630 as described in FIG. 6. In such embodiments, a user accessing the messaging interface can send and receive messages through the messaging system. In some embodiments, the messaging module 206 is implemented as a software application (e.g., social networking application, messenger application, etc.) that is capable of running on a computing device in which the client module 202 is implemented. Many variations are possible.

FIG. 3 illustrates an example automated answering module 302, according to an embodiment of the present disclosure. In some embodiments, the automated answering module 104 of FIG. 1 can be implemented with the automated answering module 302. As shown in the example of FIG. 3, the automated answering module 302 can include a communication module 304, an automated attendant module 306, a message module 308, and a message link module 310.

The communication module 304 can be configured to utilize various technologies for receiving and/or establishing voice-based communications (or calls) over various networks (e.g., the Internet, cellular networks, POTS networks, etc.). In some embodiments, the communication module 304 can establish voice-based communications (or calls) received from callers. In various embodiments, these calls can be serviced by the automated attendant module 306 as described below. In some embodiments, the communication module 304 can determine respective addresses of computing devices from which calls were made to an address associated with the communication module 304. For example, the communication module 304 can determine a phone number associated with a mobile device based on caller identification information that is provided to the communication module 304 when the call is being established. In some embodiments, addresses (e.g., phone numbers) associated with devices can be used to lookup corresponding usernames that are associated with those addresses in a messaging system (e.g., the messaging system module 106 of FIG. 1). In some embodiments, the messaging system corresponds to a social networking system 630 as described in FIG. 6. Many variations are possible.

The automated attendant module 306 can be configured to provide various options to callers during a voice call. Such options are typically communicated using pre-recorded audio by the automated answering system and may allow the caller to route a call (e.g., “press 1 for sales, press 2 for customer support, or press 3 for all other inquiries”) and/or query information (e.g., “press 1 to hear your checking account balance or press 2 to hear your savings account balance”), for example. The caller can select options, for example, by pressing the appropriate numerical key through a virtual keypad that is presented on a display screen of the caller's computing device. The virtual keypad typically may include a corresponding numerical key for each digit in the 0-9 numerical range. In general, selecting a numerical key through the virtual keypad may cause a corresponding DTMF tone (dual-tone multi-frequency signaling), or some other appropriate signal, to be sent to the automated attendant module 306. The automated attendant module 306 can determine the selected option based on the DTMF tone and can process the request accordingly. In some embodiments, the automated attendant module 306 can provide an option to initiate a messaging session over which the caller can communicate with the entity (or representatives of the entity) using text-based messages. In some embodiments, these messages may be exchanged over the messaging system (e.g., the messaging system module 106 of FIG. 1).

In some embodiments, if the caller selects the option to initiate the messaging session, the message module 308 attempts to send one or more messages to the caller through the messaging system. For example, the message module 308 can attempt to determine a username in the messaging system that is associated with the phone number corresponding to the caller's computing device. For example, the message module 308 can interact with the messaging system over an interface (e.g., application programming interface) provided by the messaging system, as described in reference to FIG. 4. In some embodiments, if a username associated with the provided phone number can be identified, the messaging system can send one or more text-based messages directly to a message inbox associated with the identified username, for example, when instructed to do so by the automated attendant module 306 through an API. These messages may provide the user with options for accessing or querying various information from the entity (e.g., account information, billing questions, etc.) or receiving some other form of customer service. Further, these messages can be sent from a username (or account) associated with the entity in the messaging system (e.g., social networking system). The user can respond with text-based messages that specify selected options and/or queries to be processed by the entity. Many variations are possible.

In some embodiments, if a username associated with the provided phone number cannot be identified, the caller is added to an answering queue to have their voice call be serviced by a live agent (e.g., customer service representative). In some embodiments, if a username associated with the provided phone number cannot be identified, the message link module 310 can send a text message (e.g., a Short Message Service, or SMS, message) to the caller's computing device over one or more networks (e.g., the Internet, cellular networks, etc.). In such embodiments, the text message can include an option (e.g., hyperlink) that can be selected to send a message to the entity (or representative of the entity) over the messaging system (e.g., social networking system). For example, in some embodiments, when the caller selects the hyperlink, the caller's computing device can launch a messaging application through which the message can be sent to the entity over the messaging system. In some embodiments, the message can be sent from a username (or account) associated with the caller in the messaging system. In such embodiments, the entity (or representatives of the entity) can access the message and respond accordingly in a messaging session established between the user and the entity over the messaging system. Many variations are possible.

FIG. 4 illustrates an example messaging system module 402, according to an embodiment of the present disclosure. In some embodiments, the messaging system module 106 of FIG. 1 can be implemented with the messaging system module 402. As shown in the example of FIG. 4, the messaging system module 402 can include a communication module 404, a user lookup module 406, a message module 408, an automated chat bot module 410, and a handover module 412.

The communication module 404 can be configured to utilize various technologies for exchanging information over various networks (e.g., the Internet, cellular networks, POTS networks, etc.). In some embodiments, the communication module 404 can provide one or more interfaces (e.g., application programming interfaces) through which automated answering systems (e.g., the automated answering module 104 of FIG. 1) can submit requests to be processed by the messaging system module 402. For example, in some embodiments, the communication module 404 provides an interface through which automated answering systems can provide addresses (e.g., phone numbers) of callers who are to be messaged through a messaging system (e.g., the social networking system 630 of FIG. 6).

In some embodiments, when an address to be messaged is received from an automated answering system, the user lookup module 406 attempts to identify a username (or login) associated with the address. For example, in some embodiments, the user lookup module 406 can maintain information describing associations between addresses (e.g., phone numbers) and usernames corresponding to users of the social networking system.

In some embodiments, if the user lookup module 406 identifies a username associated with the provided address, the message module 408 can send one or more text-based messages directly to a message inbox associated with the identified username in the messaging system. These messages can allow the user to interact with an entity (or representatives of the entity) associated with the automated answering system. In some embodiments, the message module 408 sends these messages from a username (or account) associated with the entity in the messaging system. For example, the entity may be associated with a username “Pepe's Studio” in a social networking system. In this example, messages can be sent to the user within the social networking system from the username “Pepe's Studio”. The user to whom the messages are delivered can in turn respond with their own text-based messages. These messages may specify options for interacting with the entity (or representatives of the entity) and/or queries to be serviced by the entity (or representatives of the entity). In some embodiments, the messaging system module 402 is configured to process messages received from users by routing them to one or more live agents (e.g., customer service representatives) that respond with text-based messages over the messaging system. In some embodiments, the messaging system module 402 is configured to process messages received from users using the automated chat bot module 410. In some embodiments, the automated chat bot module 410 can be trained to analyze and respond to messages with text-based messages sent over the messaging system. In such embodiments, the automated chat bot module 410 can be trained based on various artificial intelligence techniques including, for example, machine learning.

In some embodiments, the handover module 412 can disable the automated chat bot module 410 during a given messaging session. For example, in some embodiments, if the handover module 412 determines that the automated chat bot module 410 is not satisfactorily servicing user queries, as submitted in messages sent through the messaging system, the handover module 412 can disable the automated chat bot module 410 and route the user's messages to a live agent (e.g., customer service representatives, humans, etc.). In such embodiments, the live agent can continue servicing the user's queries by responding with text-based messages. In some embodiments, the handover module 412 may apply one or more machine learning models to determine when a user is not satisfied by messages sent by the automated chat bot module 410. In this example, the machine learning models can be trained to analyze and determine user discontent based on one or more messages sent by the user during the messaging session. Many variations are possible. For example, in some embodiments, the automated chat bot module 410, or portions thereof, can be implemented as an automated answering system associated with an entity. In such embodiments, the messaging system module 402 can provide the automated answering system with copies of messages that users send to the entity through the messaging system. In some embodiments, copies of messages are provided to the automated answering system as JSON (JavaScript Object Notation) objects. In such embodiments, the automated answering system can be configured to automatically analyze the messages and correspondingly generate responses that attempt to satisfy any queries submitted in the messages.

In some embodiments, if the user lookup module 406 is unable to identify a username associated with the provided phone number, the communication module 404 can notify the automated answering system that no username is associated with the provided address. In such embodiments, the automated answering system may add the caller to a voice-based answering queue serviced by live agents (e.g., customer service representatives). In some embodiments, if the user lookup module 406 is unable to identify a username associated with the provided phone number, the automated answering system can send a text message (e.g., a Short Message Service, or SMS, message) to the caller's computing device over one or more networks (e.g., cellular networks). In such embodiments, the text message can include an option (e.g., hyperlink) that can be selected to send a message to the entity (or representative of the entity) through the messaging system, as described above. In some embodiments, the option (e.g., hyperlink) can include a parameter that references a token. The token can hold information related to the messaging session including, for example, the caller's phone number and options selected by the caller during the call, to name some examples. Once the option (e.g., hyperlink) is selected, in some embodiments, one or more computing systems associated with the entity can determine the username associated with the provided phone number using information stored in the token without consulting the messaging system.

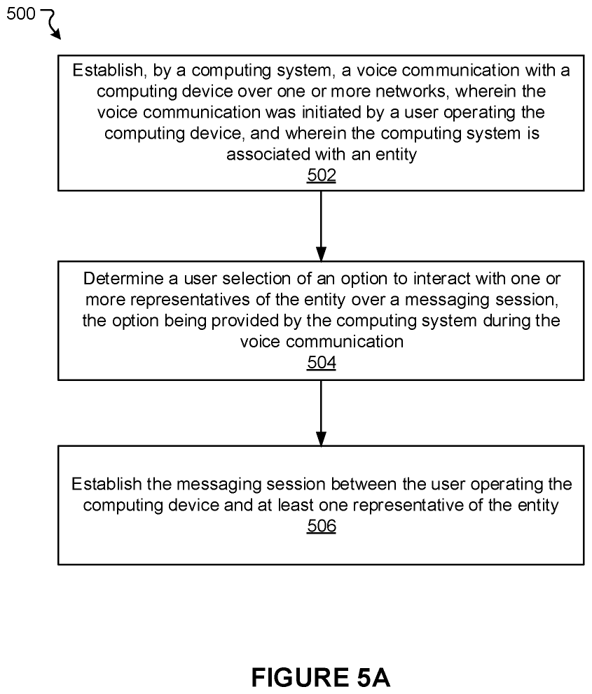

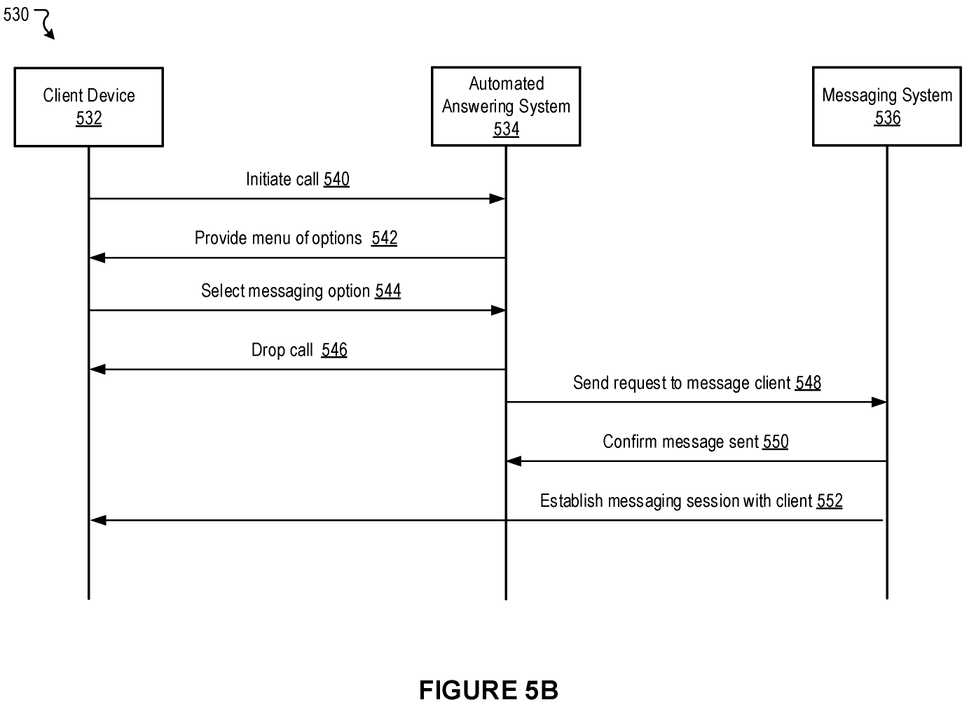

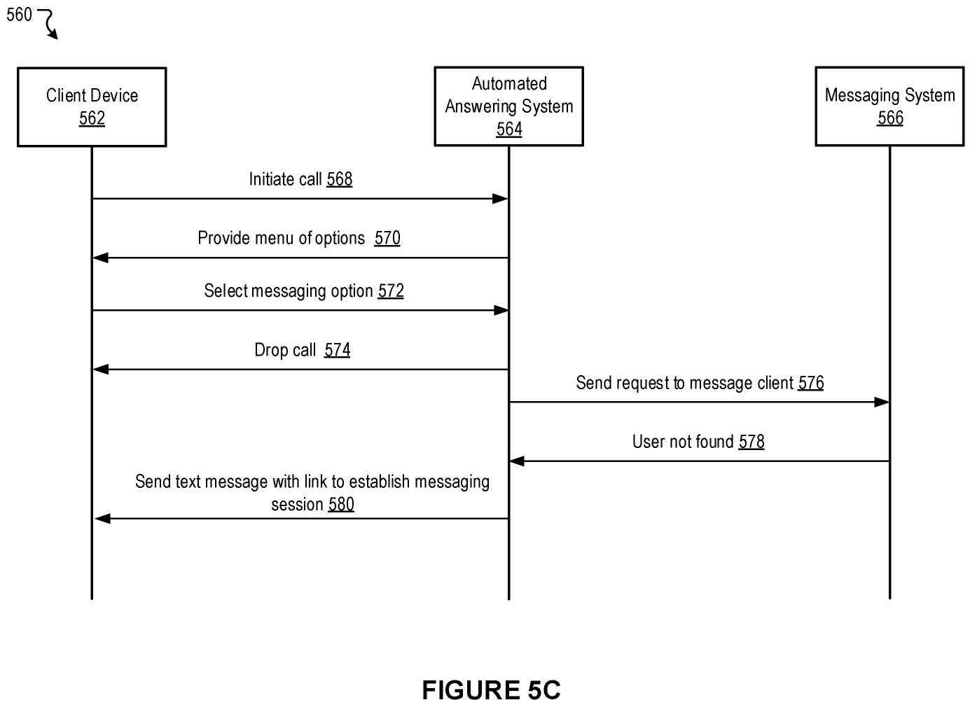

FIG. 5A illustrates an example method 500, according to an embodiment of the present disclosure. It should be appreciated that there can be additional, fewer, or alternative steps performed in similar or alternative orders, or in parallel, within the scope of the various embodiments discussed herein unless otherwise stated.

At block 502, a voice communication is established, by a computing system, with a computing device over one or more networks, wherein the voice communication was initiated by a user operating the computing device, and wherein the computing system is associated with an entity. At block 504, a user selection of an option to interact with one or more representatives of the entity over a messaging session is determined. The option can be provided by the computing system during the voice communication. At block 506, the messaging session is established between the user operating the computing device and at least one representative of the entity.

FIG. 5B illustrates an example of a diagram 530, according to an embodiment of the present disclosure. The example diagram 530 illustrates interactions between a client device 532, an automated answering system 534 associated with an entity, and a messaging system 536. It should be appreciated that there can be additional, fewer, or alternative steps performed in similar or alternative orders, or in parallel, within the scope of the various embodiments discussed herein unless otherwise stated.

In the example of FIG. 5B, a user operating the client device 532 initiates a voice call with an automated answering system 534 (540). Upon establishing the voice call, the automated answering system 534 can provide a pre-recorded menu of options to the user (542). For example, the automated answering system may provide options for navigating a phone tree and/or options for querying information. In some embodiments, the automated answering system 534 can also provide an option to communicate with the entity (or representatives of the entity) over a text-based messaging session. In the example of FIG. 5B, the user operating the client device 532 selects the option to communicate with the entity (or representatives of the entity) over a text-based messaging session (544). Once this option is selected, in some embodiments, the automated answering system 534 can drop, or disconnect, the voice call between the client device 532 and the automated answering system 534 (546). The automated answering system 534 can also interact with the messaging system 536 to submit a request for sending a text-based message to the user operating the client device 532 (548). In some embodiments, the request is processed by the messaging system 536 by identifying a username of the user as used within the messaging system 536 (e.g., social networking system). For example, in some embodiments, the messaging system 536 can identify a username that corresponds to an address (e.g., phone number) associated with the client device 532. In such embodiments, the messaging system 536 can maintain known associations between usernames and addresses (e.g., phone numbers) of corresponding user (or computing) devices. Once the username is identified, the messaging system 536 can send a confirmation to the automated answering system 534 acknowledging the request (550). The messaging system 536 can establish a messaging session between the user and the entity through the messaging system 536 (552). For example, the messaging system 536 can deliver a message to a message inbox of the identified username. The user can respond with various requests that can be provided to the entity as text-based messages sent over the messaging system. Many variations are possible. In various embodiments, the user can exchange messages with the entity (or representatives of the entity) by accessing the messaging system using a software application (e.g., web browser) and/or using a standalone messaging application running on the user's client device 532. Many variations are possible.

FIG. 5C illustrates an example of a diagram 560, according to an embodiment of the present disclosure. The example diagram 560 illustrates interactions between a client device 562, an automated answering system 564 associated with an entity, and a messaging system 566. It should be appreciated that there can be additional, fewer, or alternative steps performed in similar or alternative orders, or in parallel, within the scope of the various embodiments discussed herein unless otherwise stated.

In the example of FIG. 5C, a user operating the client device 562 initiates a voice call with an automated answering system 564 (568). Upon establishing the voice call, the automated answering system 564 can provide a pre-recorded menu of options to the user (570). In some embodiments, the automated answering system 564 can also provide an option to communicate with the entity (or representatives of the entity) over a text-based messaging session. In the example of FIG. 5C, the user operating the client device 562 selects the option to communicate with the entity (or representatives of the entity) over a text-based messaging session (572). Once this option is selected, in some embodiments, the automated answering system 564 can drop, or disconnect, the voice call between the client device 562 and the automated answering system 564 (574). The automated answering system 564 can also interact with the messaging system 566 to submit a request for sending a text-based message to the user operating the client device 562 (576). In some embodiments, the request is processed by the messaging system 566 by identifying a username of the user as used within the messaging system 566 (e.g., social networking system). If a username cannot be identified, the messaging system 566 can notify the automated answering system 564 (578). In some embodiments, if a username cannot be identified, the automated answering system 564 (or some other designated system) can send a text message (e.g., a Short Message Service, or SMS, message) to the client device 562 (580). In such embodiments, the text message can include an option (e.g., hyperlink) that can be selected to send a message to the entity (or representative of the entity) through the messaging system. For example, in some embodiments, when the user selects the option, the client device 562 can launch a messaging application through which the message can be sent to the entity over the messaging system. Many variations are possible.

It is contemplated that there can be many other uses, applications, and/or variations associated with the various embodiments of the present disclosure. For example, in some cases, user can choose whether or not to opt-in to utilize the disclosed technology. The disclosed technology can also ensure that various privacy settings and preferences are maintained and can prevent private information from being divulged. In another example, various embodiments of the present disclosure can learn, improve, and/or be refined over time.

### Social Networking System—Example Implementation

FIG. 6 illustrates a network diagram of an example system 600 that can be utilized in various scenarios, in accordance with an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices (or systems) that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a computing device or a device having computer functionality, such as a smart-phone, a tablet, a personal digital assistant (PDA), a mobile telephone, a laptop computer, a wearable device (e.g., a pair of glasses, a watch, a bracelet, etc.), a camera, an appliance, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the Silverlight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content. As discussed previously, it should be appreciated that there can be many variations or other possibilities.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a messaging system module 646. The messaging system module 646 can, for example, be implemented as the messaging system module 106 of FIG. 1. In some embodiments, the user device 610 can include a client module 618. The client module 618 can, for example, be implemented as the client module 102 of FIG. 1. In some embodiments, an automated answering module 662 can be implemented in an automated answering system 660. The automated answering module 662 can, for example, be implemented as the automated answering module 104 of FIG. 1. As discussed previously, it should be appreciated that there can be many variations or other possibilities.

### Hardware Implementation

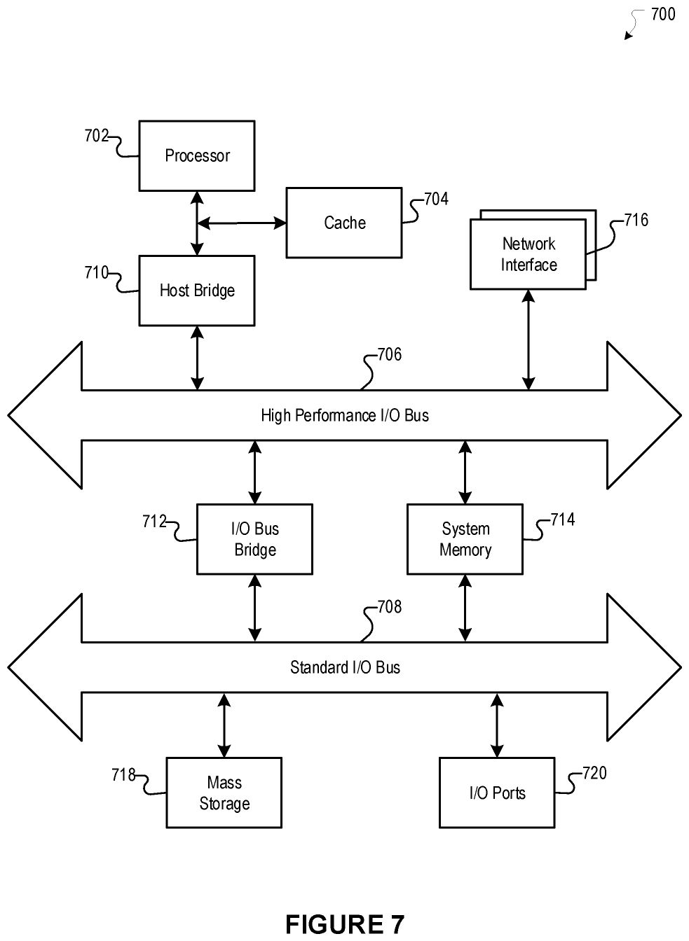

The foregoing processes and features can be implemented by a wide variety of machine and computer system architectures and in a wide variety of network and computing environments. FIG. 7 illustrates an example of a computer system 700 that may be used to implement one or more of the embodiments described herein in accordance with an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 720, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif. and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

1. A computer-implemented method comprising:
establishing, by a computing system, a voice communication with a computing device over one or more networks, wherein the voice communication was initiated by the computing device, and wherein the computing system is associated with an entity;
determining, by the computing system, a selection of an option to interact with one or more representatives of the entity over a messaging session, wherein the option is provided during the voice communication;
establishing, by the computing system, the messaging session between the computing device and at least one representative of the entity, wherein the establishing the messaging session further comprises:
determining, by the computing system, whether an association exists between a user and an address associated with the computing device; and
in response to determining that no association exists between a user and the address associated with the computing device,
causing, by the computing system, at least one text-based message to be sent to the address associated with the computing device, wherein the text-based message includes a hyperlink that can be selected to send a message to the computing system associated with the entity through a software application associated with the computing device;
determining, by the computing system, a message sent to the computing system associated with the entity through the software application in response to the at least one text-based message sent to the address associated with the computing device;
determining, by the computing system, a user of the software application based on the message sent to the computing system associated with the entity; and
determining, by the computing system, an association between the user and the address associated with the computing device based on the message sent to the computing system associated with the entity through the software application associated with the computing device
determining, by the computing system, a subsequent message sent to the computing system associated with the entity through the software application;
determining, by the computing system, a level of user discontent associated with the subsequent message based on at least one machine learning model that is trained to analyze the subsequent message and predict the level of user discontent and
determining, by the computing system, whether to provide the subsequent message to be processed by an automated chat bot or the at least one representative of the entity based at least in part on the level of user discontent associated with the subsequent message.

2. The computer-implemented method of claim 1, wherein the user and the at least one representative are able to exchange text-based messages through the messaging session.

3. The computer-implemented method of claim 1, wherein the at least one representative is a human.

4. The computer-implemented method of claim 1, wherein the messaging session is established through a social networking system.

5. The computer-implemented method of claim 1, wherein the option for interacting with the entity over the messaging session is provided among a menu of options for interacting with the entity.

6. The computer-implemented method of claim 1, wherein establishing the messaging session further comprises:
determining, by the computing system, a username of the user based at least in part on the address; and
causing, by the computing system, at least one text-based message addressed to the username be sent through a social networking system.

7. The computer-implemented method of claim 6, wherein determining the username of the user based at least in part on the address further comprises:
determining, by the computing system, a phone number associated with the computing device; and
determining, by the computing system, a username associated with the phone number.

8. (canceled)

9. The computer-implemented method of claim 1, wherein the at least one text-based message is sent to a phone number associated with the computing device, and wherein selection of the option permits the user to send an instant message to the at least one representative of the entity over a social networking system.

10. The computer-implemented method of claim 1, wherein the computing system is an automated answering system.

11. A system comprising:
at least one processor; and
a memory storing instructions that, when executed by the at least one processor, cause the system to perform:
establishing a voice communication with a computing device over one or more networks, wherein the voice communication was initiated by the computing device, and wherein the system is associated with an entity;
determining a selection of an option to interact with one or more representatives of the entity over a messaging session, wherein the option is provided during the voice communication;
establishing the messaging session between the computing device and at least one representative of the entity, wherein the establishing the messaging session further comprises:
determining whether an association exists between a user and an address associated with the computing device; and
in response to determining that no association exists between a user and the address associated with the computing device,
causing at least one text-based message to be sent to the address associated with the computing device, wherein the text-based message includes a hyperlink that can be selected to send a message to the system associated with the entity through a software application associated with the computing device;
determining a message sent to the system associated with the entity through the software application in response to the at least one text-based message sent to the address associated with the computing device;
determining a user of the software application based on the message sent to the system associated with the entity; and
determining an association between the user and the address associated with the computing device based on the message sent to the system associated with the entity through the software application associated with the computing device;
determining a subsequent message sent to the system associated with the entity through the software application;
determining a level of user discontent associated with the subsequent message based on at least one machine learning model that is trained to analyze the subsequent message and predict the level of user discontent and
determining whether to provide the subsequent message to be processed by an automated chat bot or the at least one representative of the entity based at least in part on the level of user discontent associated with the subsequent message.

12. The system of claim 11, wherein the user and the at least one representative are able to exchange text-based messages through the messaging session.

13. The system of claim 11, wherein the at least one representative is a human.

14. The system of claim 11, wherein the messaging session is established through a social networking system.

15. The system of claim 11, wherein the option for interacting with the entity over the messaging session is provided among a menu of options for interacting with the entity.

16. A non-transitory computer-readable storage medium including instructions that, when executed by at least one processor of a computing system, cause the computing system to perform a method comprising:
establishing a voice communication with a computing device over one or more networks, wherein the voice communication was initiated by the computing device, and wherein the computing system is associated with an entity;
determining a selection of an option to interact with one or more representatives of the entity over a messaging session, wherein the option is provided during the voice communication;
establishing the messaging session between the computing device and at least one representative of the entity, wherein the establishing the messaging session further comprises:
determining whether an association exists between a user and an address associated with the computing device; and
in response to determining that no association exists between a user and the address associated with the computing device,
causing at least one text-based message to be sent to the address associated with the computing device, wherein the text-based message includes a hyperlink that can be selected to send a message to the computing system associated with the entity through a software application associated with the computing device;
determining a message sent to the computing system associated with the entity through the software application in response to the at least one text-based message sent to the address associated with the computing device;
determining a user of the software application based on the message sent to the computing system associated with the entity; and
determining an association between the user and the address associated with the computing device based on the message sent to the computing system associated with the entity through the software application associated with the computing device
determining a subsequent message sent to the computing system associated with the entity through the software application;
determining a level of user discontent associated with the subsequent message based on at least one machine learning model that is trained to analyze the subsequent message and predict the level of user discontent and
determining whether to provide the subsequent message to be processed by an automated chat bot or the at least one representative of the entity based at least in part on the level of user discontent associated with the subsequent message.

17. The non-transitory computer-readable storage medium of claim 16, wherein the user and the at least one representative are able to exchange text-based messages through the messaging session.

18. The non-transitory computer-readable storage medium of claim 16, wherein the at least one representative is a human.

19. The non-transitory computer-readable storage medium of claim 16, wherein the messaging session is established through a social networking system.

20. The non-transitory computer-readable storage medium of claim 16, wherein the option for interacting with the entity over the messaging session is provided among a menu of options for interacting with the entity.
